(19) United States
(12) Patent Application Publication
(10) Pub. No.: US 2011/0157000 A1
(43) Pub. Date: Jun. 30, 2011

(54) PROJECTION SYSTEM AND METHOD

(75) Inventor: CHIEN-LIN CHEN, Tu-Cheng (TW)

(73) Assignee: HON HAI PRECISION INDUSTRY CO., LTD., Tu-Cheng (TW)

(21) Appl. No.: 12/816,342

(22) Filed: Jun. 15, 2010

(30) Foreign Application Priority Data
Dec. 31, 2009 (TW) 98146243

(51) Int. Cl. G09G 5/00; H04N 7/18

(52) U.S. Cl. 345/156; 348/159; 348/E07.091

(57) ABSTRACT

A projection system includes first and second cameras, a projector, and a processing unit. The first camera captures an object to obtain an image of the object. The projector projects the image of the object and a number of symbols to a projection region. The symbols in the projection region forms controlling symbols. The second camera captures the projection region to obtain an image of the projection region. The image of the projection region is detected to determine whether one controlling symbol is selected. If a controlling symbol is selected, the processing unit controls the first camera, the second camera, or the projector correspondingly.

### BACKGROUND

1. Technical Field

The present disclosure relates to a projection system and a projection method.

2. Description of Related Art

Projectors are often used by teachers or presenters to project teaching material onto a screen. When the teacher wants to process the teaching materials, such as changing pages of the teaching materials, the teacher needs to return to the computer system to do so, or remain at the computer, unable to move around in the classroom, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a projection system used in a classroom, with the projection system including a storage unit.

FIG. 2 is a block diagram of the storage unit of FIG. 1.

FIGS. 3-5B are schematic diagrams of the projection system operations of FIG. 1.

FIG. 6 is a flowchart of an exemplary embodiment of a projection method.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

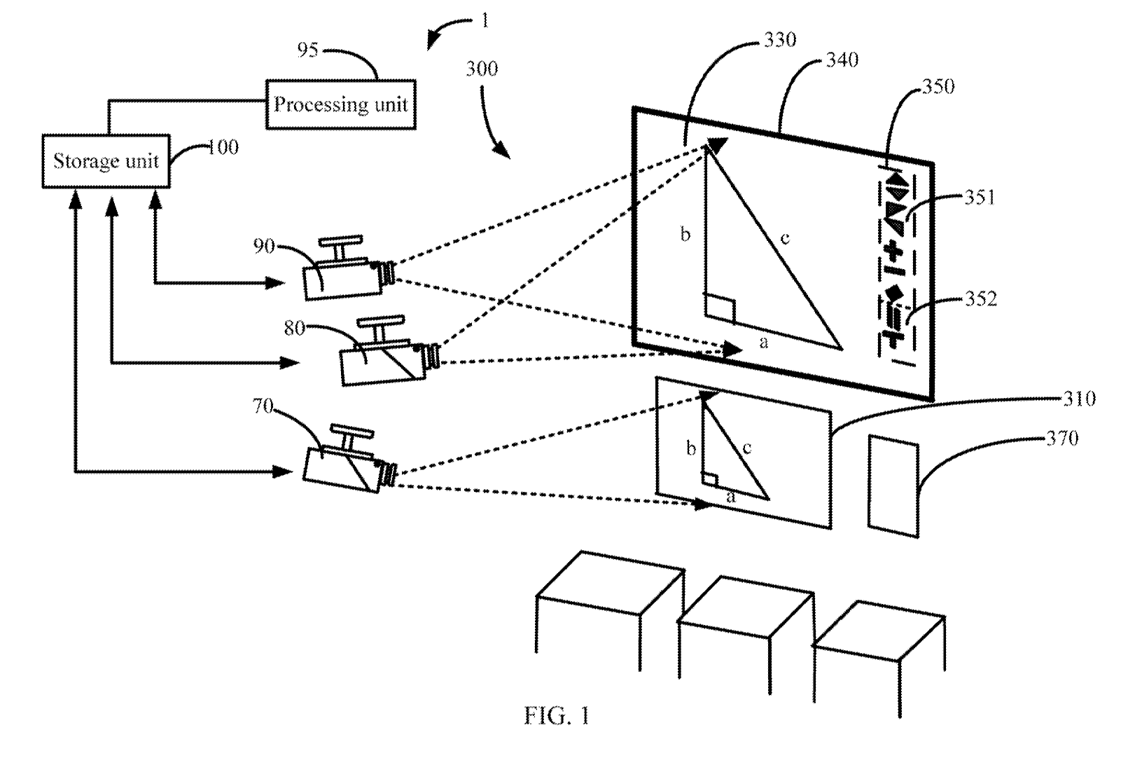

Referring to FIG. 1, an exemplary embodiment of a projection system 1 includes a first camera 70, a second camera 80, a projector 90, a storage unit 100, and a processing unit 95. The projection system 1 may be used in a group setting such as in a classroom.

The first camera 70 can be used to capture images of an object, such as a chalkboard. The first camera 70 then transmits the images to the storage unit 100. The projector 90 receives the images from the storage unit 100 and projects the images on a projection region 330. The second camera 80 can be used to capture images of the projection region and transmits the images to the storage unit 100. The processing unit 95 accesses the images stored in the storage unit 100 and analyzes the images to control the first camera 70, the second camera 80, or the projector 90. In the embodiment, the first camera 70 and the second camera 80 are pan/tilt/zoom (PTZ) cameras.

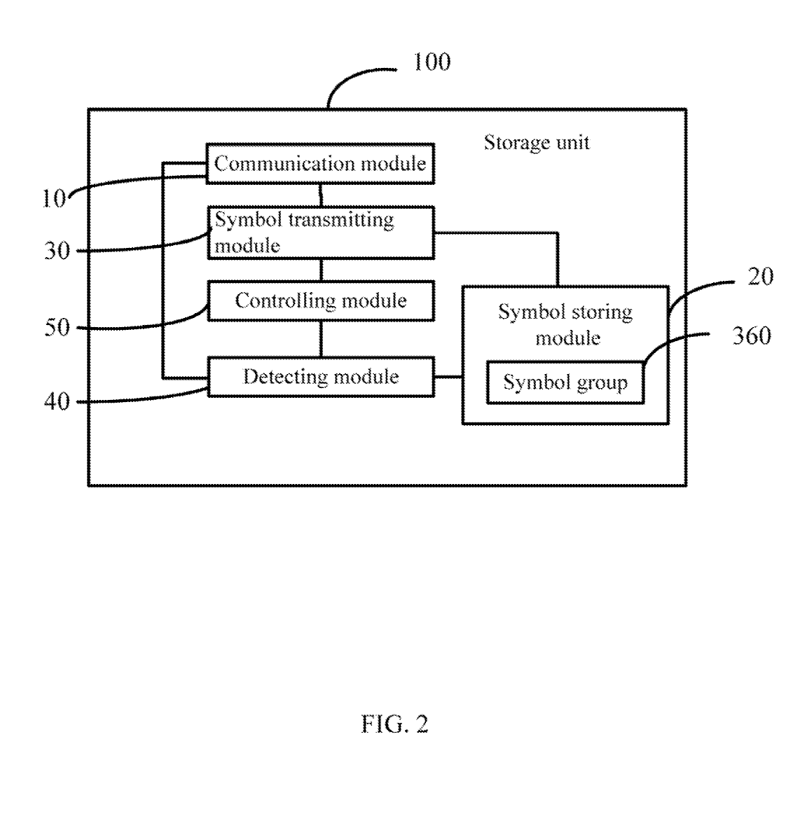

Referring to FIG. 2, the storage unit 100 includes a communication module 10, a symbol storing module 20, a symbol transmitting module 30, a detecting module 40, and a controlling module 50. The communication module 10, the symbol transmitting module 30, the detecting module 40, and the controlling module 50 may include one or more computerized instructions and are executed by the processing unit 95.

The communication module 10 transmits the images of the object from the first camera 70 to the projector 90. The projector 90 projects the images to the projection region 330. In addition, the communication module 10 also transmits the images of the projection region 330 from the second camera 80 to the detecting module 40.

The symbol storing module 20 stores a symbol group 360. The symbol group 360 includes a plurality of first symbols, such as “+” and “−”. In other embodiments, the symbol group 360 further includes a plurality of symbol pairs. Each symbol pair includes two second symbols.

The symbol transmitting module 30 transmits the first symbols and one of the two second symbols in each symbol pair to the projector 90. The projector 90 projects the images from the first camera 70, the first symbols, and the second symbols to the projection region 330. The first symbols and the second symbols on the projection region 330 form a plurality of first controlling symbols 351 and a plurality of second controlling symbols 352, respectively. Each first control symbol represents a controlling action. For example, “+” stands for zooming in with the first camera 70.

The detecting module 40 detects the images of the projection region 330 from the second camera 80, to determine whether the first and second controlling symbols 351 and 352 are selected. In the embodiment, the detecting module 40 determines whether one of the first and second controlling symbols is covered, perhaps by the teachers finger or pointer, to know whether one of the controlling symbol is selected. When one of the first and second controlling symbols is not in the images anymore, the controlling symbol is regarded as being hidden. When one of the first and second controlling symbols is selected, the detecting module 40 transmits a detection signal corresponding to the selected controlling symbol to the controlling module 50.

The controlling module 50 controls the first camera 70, the second camera 80, or the projector 90 according to the detection signal from the detecting module 40. For example, when “+” is selected, the controlling module 50 controls a lens of the first camera 70 to withdraw. As a result, an image of the object with a larger size is projected on the projection region 330.

Referring to FIG. 1, the projection system 1 is used in a classroom 300. A chalkboard 310 is in the classroom 300, and the chalkboard 310 is regarded as the object. The first camera 70 captures images of the chalkboard 310. The communication module 10 transmits the images of the chalkboard 310 to the projector 90. The projector 90 projects the images of the chalkboard 310 to the projection region 330. The projection region 330 may be a screen in the classroom 300. The projection region 330 includes an edge 340.

In the embodiment, the symbol group 360 includes the plurality of first symbols and two symbol pairs. The first symbols include “▴”, “▾”, [symbol] “+”, “−”, and “♦”. The two symbol pairs include a first symbol pair including “∥”, “=”, and a second symbol pair including [symbol] “▴” represents to move the first camera 70 up. “▾” represents to move the first camera 70 down. [symbol] represents to move the first camera 70 right. [symbol] represents to move the first camera 70 left. “+” represents to zoom-in the images of the chalkboard 310. “−” represents to zoom-out the images of the chalkboard 310. “♦” represents to connect the projector 90 to other devices, such as a computer system.

The symbol transmitting module 30 transmits the first symbols “▴”, “▾”, [symbol] [symbol] “+”, “−”, “♦”, and two of the second symbols “∥” and [symbol] to the projector 90. The projector 90 projects the images of the chalkboard 310 and the symbols in the projection region 330. The images of the first symbols form the first controlling symbols 351. The images of the two second symbols form the two second controlling symbols 352. In this embodiment, the first and second controlling symbols 351 and 352 are arranged in a column and on the right side of the projection region 330. The right side of the projection region 330 including the first controlling symbols 351 and the two second controlling symbols 352 is regarded as a controlling region 350. In other embodiments, the controlling region 350 may be placed in other positions of the projection region 330. Further, the first controlling symbols 351 and the two second symbols 352 may be arranged in other modes, such as in two lines.

The second camera 80 captures images of the projection region 330. The communication module 10 also transmits the images of the projection region 330 from the second camera 80 to the detecting module 40.

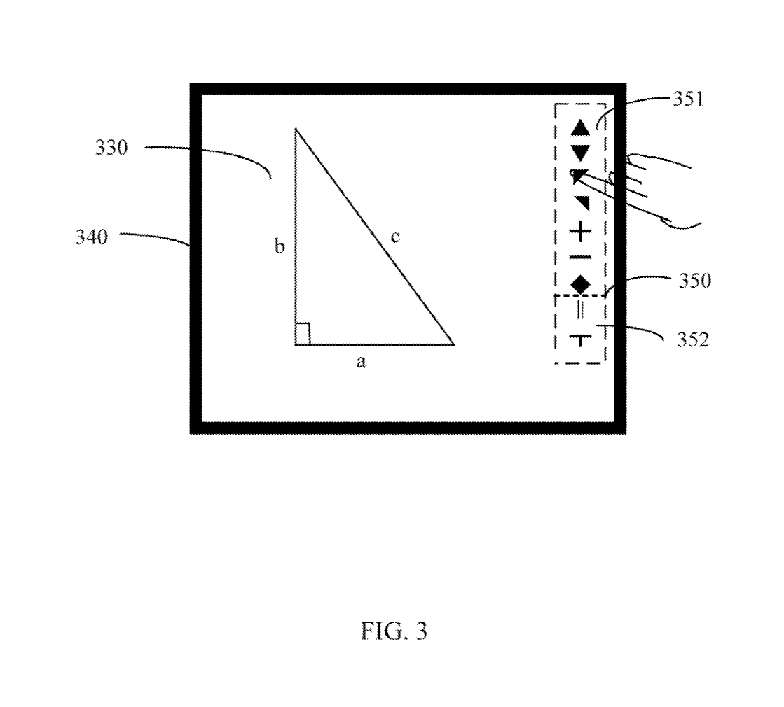

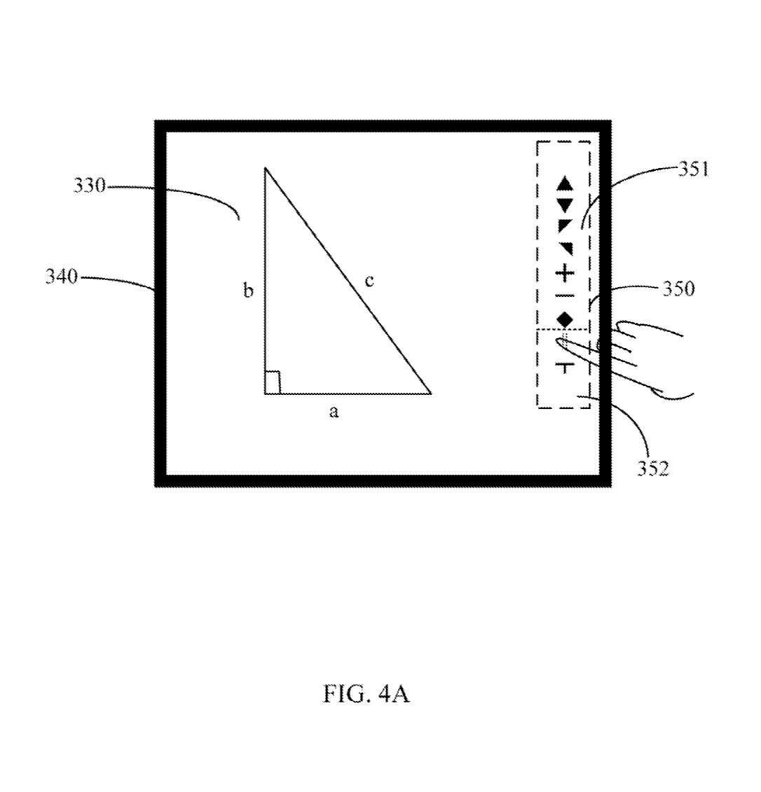

Referring to FIG. 3, when an user uses a finger to cover one of the first controlling symbol [symbol] in the controlling region 350, pixel values of a position of the first controlling symbol [symbol] in the image change. As a result, the detecting module 40 outputs a corresponding detection signal to the controlling module 50. In the embodiment, the detecting module 40 stores an image when the controlling region 350 is not selected. When the detecting module 40 receives an image from the second camera 80, the detecting module 40 compares the two images to determine which controlling symbol is selected.

The controlling module 50 controls the first camera 70 to move right. At this condition, the first camera 70 captures an image of an object on the right of the chalkboard 310, such as a duty list 370. The image of the duty list 370 is transmitted to the projector 90.

In the embodiment, after the detecting module 40 determines that one of the second controlling symbols “∥” and [symbol] is selected, the controlling module 50 controls the symbol transmitting module 30 to transmit the other second symbol “=” or [symbol] correspondingly to the projector 90. The projector 90 projects the second symbol “=” or [symbol] in the controlling region 350. The selected second controlling symbol “∥” or [symbol] changes to another second controlling symbol “=” or

[symbol]

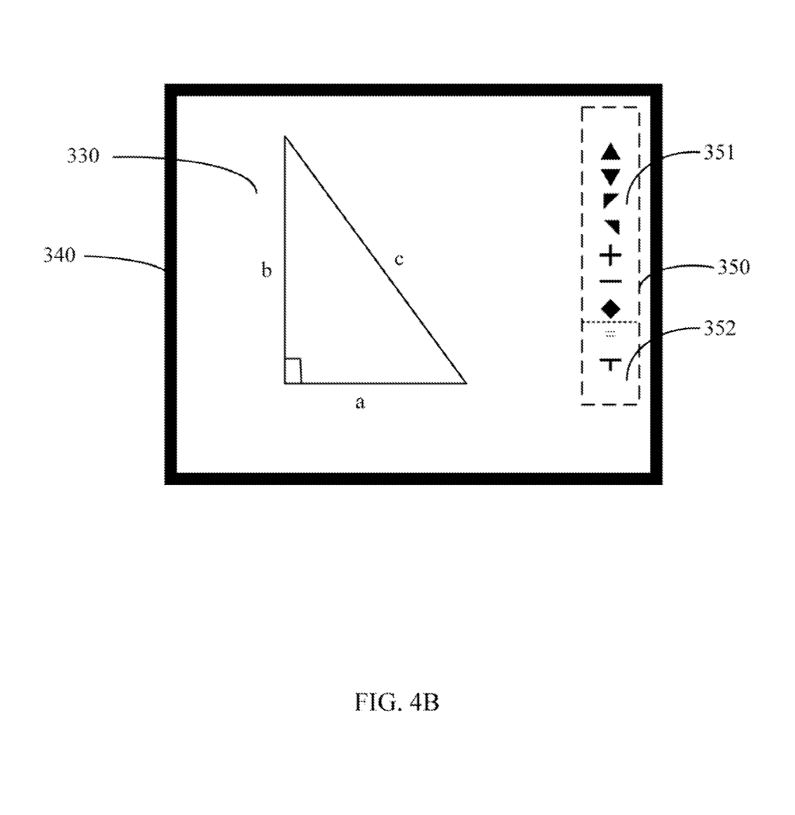

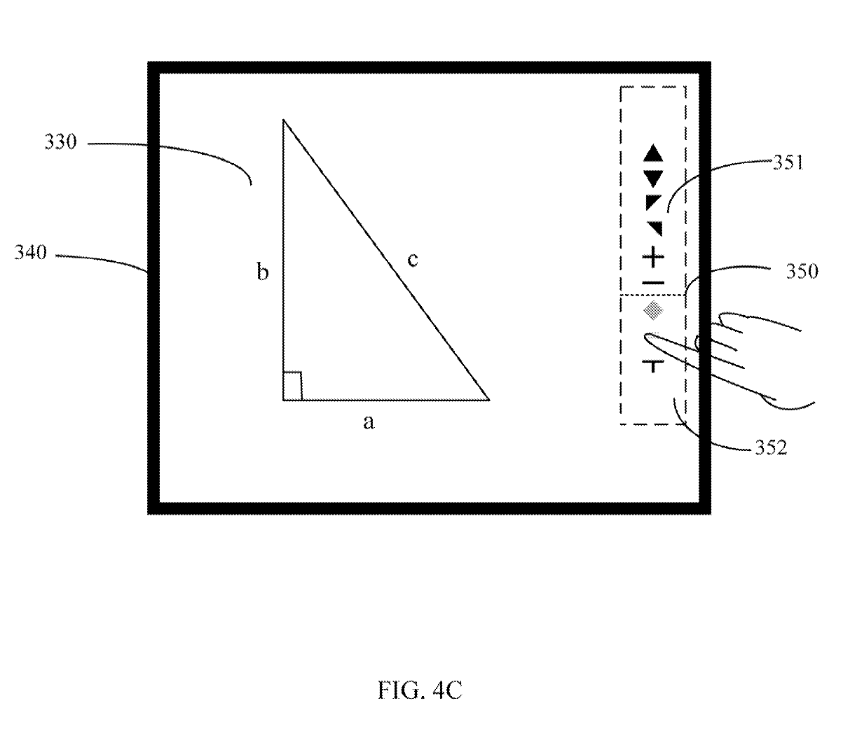

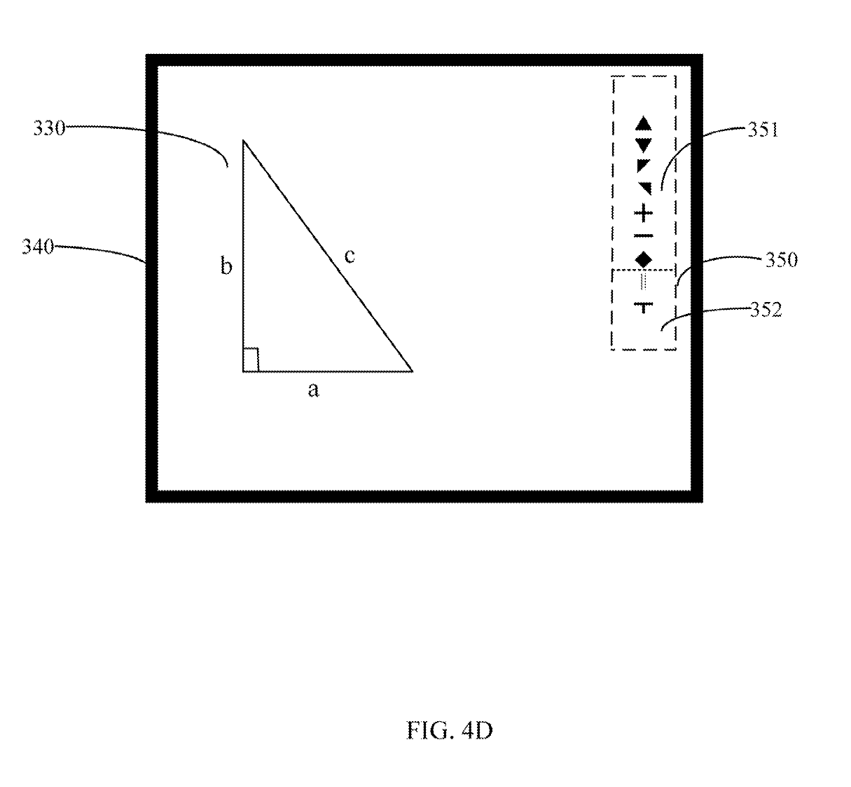

Referring to FIGS. 4A to 4D, the second controlling symbol “∥” stands for the first camera 70 being activated. The second controlling symbol “=” stands for the first camera 70 being deactivated. In the embodiment, when the projection system 1 is powered on, the symbol transmitting module 30 transmits the second symbol “∥” to the projector 90, to form the second controlling symbol “∥” in the controlling region 350 (shown in FIG. 4A). When the detecting module 40 determines that one of the second controlling symbol “∥” is selected, the controlling module 50 deactivates the first camera 70, and controls the symbol transmitting module 30 to transmit the second symbol “=” to the projector 90. The projector 90 projects the second symbol “=” in the controlling region 350 to form the second controlling symbol “=”. The second controlling symbol “∥” on the projection region 330 changes to the second controlling symbol “=” (shown in FIG. 4B). The second controlling symbol “=” in the controlling region 350 indicates the first camera 70 is deactivated.

When the user wants to activate the first camera 70 again, the second controlling symbol such as “=” is selected (shown in FIG. 4C). The controlling module 50 activates the first camera 70, and controls the symbol transmitting module 30 to transmit another second symbol “∥” to the projector 90. The projector 90 projects the second symbol “∥” in the controlling region 350 to form another second controlling symbol “∥”. When selected, the second controlling symbol “=” in the controlling region 350 changes to the second controlling symbol “∥” (shown in FIG. 4D). The second controlling symbol “∥” in the controlling region 350 indicates the first camera 70 is activated.

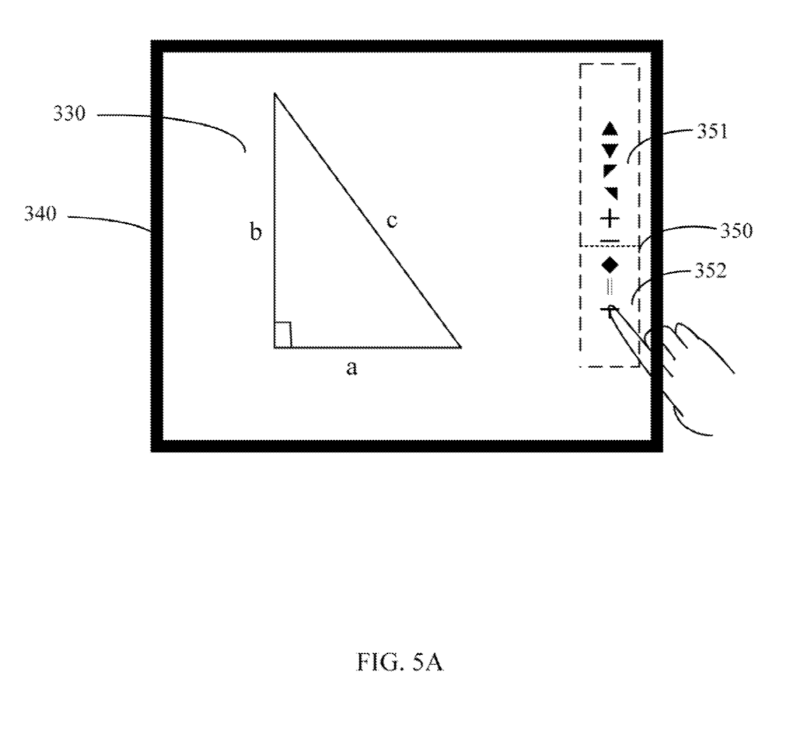

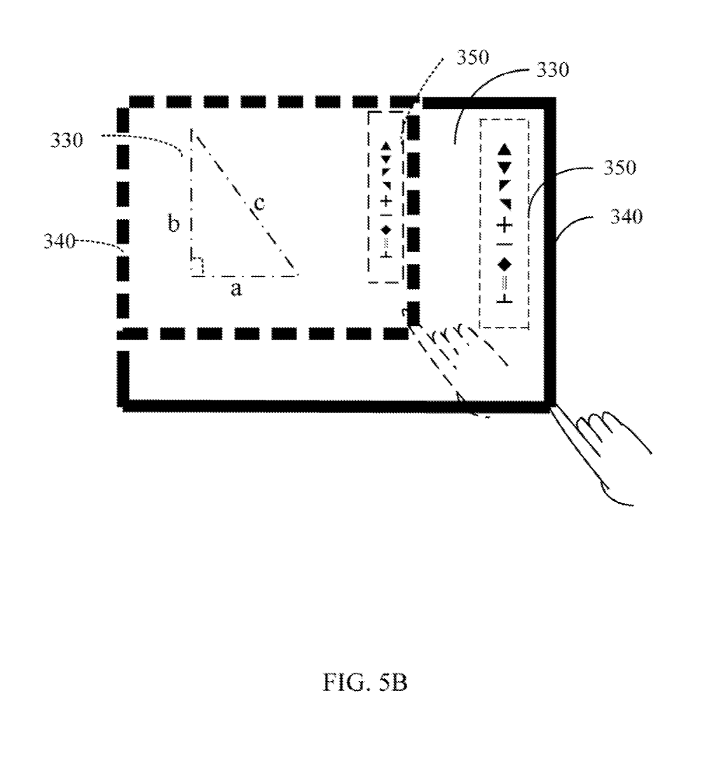

Referring to the FIGS. 5A and 5B, the second controlling symbol [symbol] indicates that the projection region 330 cannot be dragged. The second controlling symbol [symbol] indicates that the projection region 330 can be dragged.

Similar to the two second controlling symbols “∥” and “=”, when one of the second controlling symbols [symbol] is selected (shown in FIG. 5A), the second controlling symbol [symbol] in the controlling region 350 changes to the second controlling symbol [symbol] The projection region 330 can be dragged at this time. For example, the finger selects the edge 340 of the projection region 330, and moves along the screen. The detecting module 40 detects the action of the finger, and determines an orientation and a distance the figure moves to output a corresponding detection signal to the controlling module 50. The controlling module 50 controls the projector 90 to change a size of the projection region 330. As shown in FIG. 5B, when the figure selects the edge 340 of the projection region 330, and moves to the lower right, the projection region 330 becomes larger.

In other embodiments, when one of the first or second controlling symbols is selected, the controlling module 40 may change the color of the selected controlling symbol to show the user that the controlling symbol is selected at this time.

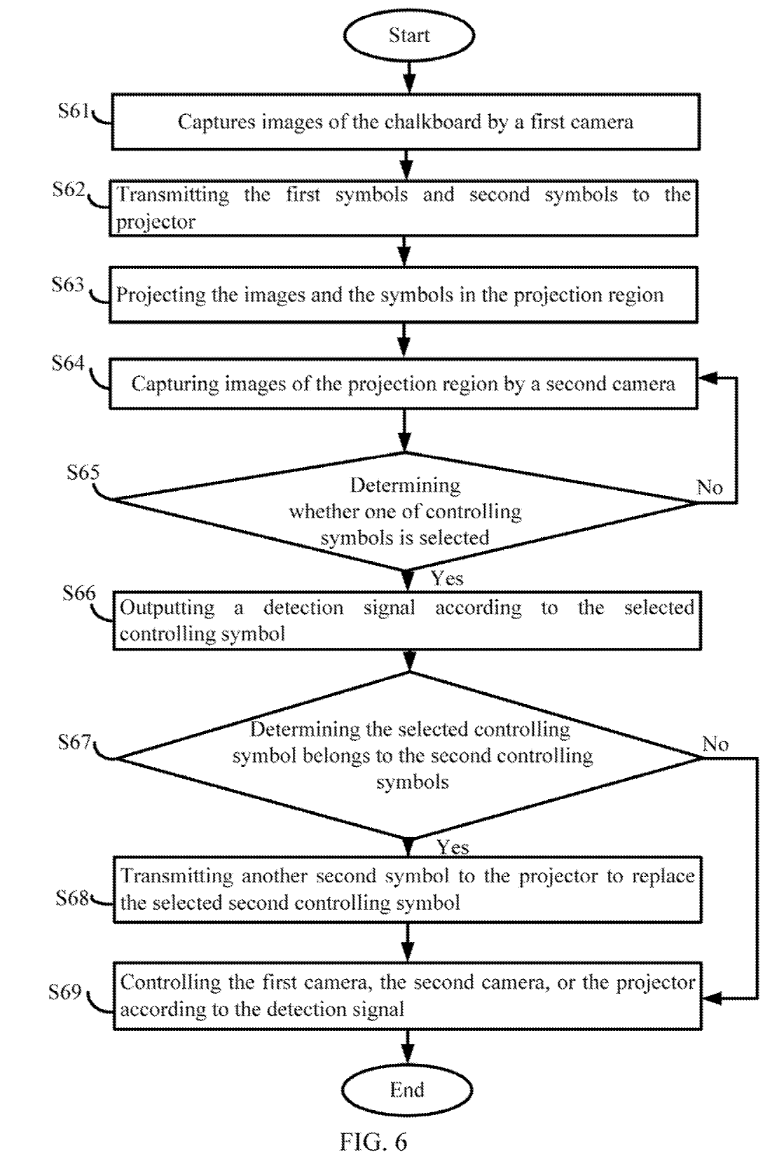

Referring to FIG. 6, an exemplary embodiment of a projection method includes the following steps.

In step S61, the first camera 70 captures images of the chalkboard 310.

In step S62, the symbol transmitting module 30 transmits the first symbols and one of the second symbols in each symbol pair in the symbol group 360 to the projector 90.

In step S63, the projector 90 projects the images of the chalkboard 310 and the symbols in the projection region 330. The first symbols form the first controlling symbols in the projection region 330. The two second symbols form the two second controlling symbols in the projection region 330.

In step S64, the second camera 80 captures images of the projection region 330.

In step S65, the detecting module 40 detects the images from the second camera 80 to determine whether one of the controlling symbols is selected. Upon the condition that there is a controlling symbol selected, the process flows to step S66. Upon the condition that there is no controlling symbol selected, the process returns to S64.

In step S66, the detecting module 40 outputs a detection signal according to the selected controlling symbol, to the controlling module 50.

In step S67, the controlling module 40 determines the selected controlling symbol belongs to the first controlling symbols or the second controlling symbols. Upon the condition that the selected controlling symbol belongs to the second controlling symbols, the process flows to step S68. Upon the condition that the selected controlling symbol belongs to the first controlling symbols, the process flows to step S69.

In step S68, the controlling module 40 controls the symbol transmitting module 30 to transmit the other symbol corresponding to the selected controlling symbol in the symbol pair to the projector 90. For example, if the selected controlling symbol is “∥”, the symbol transmitting module 30 transmits the second symbol “=” to the projector 90. The projector 90 projects the second symbol “=” to the controlling region 350 to form the second controlling symbol “=”. The second controlling symbol “∥” changes to the second controlling symbol “=”. The process flows to step 69.

In step S69, the controlling module 50 controls the first camera 70, the second camera 80, or the projector 90 according to the detection signal.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A projection system comprising:
a first camera to capture an object to obtain a first image of the object;
a projector to project the image of the object to a projection region;
a second camera to capture the projection region to obtain a second image of the projection region;
a processing unit connected between each of the first camera and the second camera, and the projector; and
a storage unit connected to the processing unit and storing a plurality of programs to be executed by the processing unit, wherein the storage unit comprises:
a communication module to transmit the first image of the object to the projector;
a symbol transmitting module to transmit a plurality of symbols to the projector, wherein the projector projects the plurality of symbols in the projection region to form a plurality of controlling symbols;
a detecting module to detect the second image of the projection region to determine whether one of the plurality of controlling symbols is selected, and to output a detection signal according to the selected controlling symbol upon the condition that one of the plurality of controlling symbols is selected; and
a controlling module to control the first camera, the second camera, or the projector according to the detection signal.

2. The projection system of claim 1, wherein the detecting module further stores a third image upon the condition that the plurality of controlling symbols are not selected, and after the detecting module receives the second image of the projection region, the detecting module compares the second and third images to determine whether one of the plurality of controlling symbols is selected.

3. The projection system of claim 1, wherein the first camera and the second camera are Pan/Tilt/Zoom cameras.

4. The projection system of claim 1, wherein the plurality of symbols comprises a plurality of first symbols and a plurality of symbol pairs, each symbol pair comprises two second symbols, the symbol transmitting module transmits the plurality of first symbols to the projector to form a plurality of first controlling symbols in the projection region, and transmits each second symbol in the plurality of symbol pairs to the projector to form a plurality of second controlling symbols; wherein upon the condition that one of the plurality of first controlling symbols is selected, the controlling module controls the first camera, the second camera, or the projector according to the detection signal; upon the condition that one of the plurality of second controlling symbols is selected, the controlling module controls the symbol transmitting module to transmit the second symbol corresponding to the selected second controlling symbol in the symbol pairs to the projector to replace the selected second controlling symbol.

5. A projection method comprising:
capturing an object to obtain a first image of the object by a first camera;
transmitting a plurality of symbols to a projector;
projecting the first image of the object and the plurality of symbols to a projection region, wherein the plurality of symbols form a plurality of controlling symbols;
capturing the projection region to obtain a second image of the projection region by a second camera;
detecting the second image of the projection region to determine whether one of the plurality of controlling symbols is selected;
outputting a detection signal according to the selected controlling symbol upon the condition that one of the plurality of controlling symbols is selected; and
controlling the first camera, the second camera, or the projector according to the detection signal.

6. The projection method of claim 5, wherein the step of “detecting the second image of the projection region to determine whether one of the plurality of controlling symbols is selected” comprises:
comparing the second image of the projection region and a third image of the projection region upon the condition that the plurality of controlling symbols are not selected, to determine whether one of the plurality of controlling symbols is selected.

7. The projection method of claim 5, wherein the step of “detecting the second image of the projection region to determine whether one of the plurality of controlling symbols is selected” comprises:
determining whether one of the plurality of controlling symbols is covered to determine whether one of the plurality of controlling symbols is selected.

8. The projection method of claim 5, wherein the plurality of symbols comprises a plurality of first symbols and a plurality of symbol pairs, each symbol pair comprises two second symbols, the plurality of first symbols form a plurality of first controlling symbols in the projection region, and each second symbol in the plurality of symbol pairs forms a plurality of second controlling symbols.

9. The projection method of claim 8, between the step of “outputting a detection signal according to the selected controlling symbol upon the condition that one of the plurality of controlling symbols is selected” and the step of “controlling the first camera, the second camera, or the projector according to the detection signal”, further comprising:
determining whether the selected controlling symbol belongs to the first controlling symbols or the second controlling symbols;
transmitting the other second symbol corresponding to the selected second controlling symbol in the symbol pairs to the projector to replace the selected second controlling symbol upon the condition that the selected controlling symbol belongs to the second controlling symbols; and
executing the step of “controlling the first camera, the second camera, or the projector according to the detection signal” upon the condition that the selected controlling symbol does not belong to the second controlling symbols.
